(19) United States
(12) Patent Application Publication
(10) Pub. No.: US 2005/0183278 A1
(43) Pub. Date: Aug. 25, 2005

(54) Electronically coded device measuring well depth information

(76) Inventors: John B. Broadhead, West Jordan, UT (US); Raj M. Patil, Great Falls, VA (US); Timothy A. Poole, Salt Lake City, UT (US)

Correspondence Address: Timothy A. Poole;Suite 200, 2540 East Bengal Blvd., Salt Lake City, UT, 84121, US

(21) Appl. No.: 10/786,857

(22) Filed: Feb. 24, 2004

(51) Int. Cl. G01B 3/12

(52) U.S. Cl. 33/735

(57) ABSTRACT

A well depth measuring device that collects depth data so operators do not have to manually record the data in the field and then again into a computer. The well measuring device is attached to the well head. A rotary encoder rotates as a probe/sensor is lowered into the well via a longitudinal strip of tape. The rotary encoder sends pulses to electrical circuitry and a handheld computer that stores longitudinal information. The stored information can be easily transferred to other computers and databases.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF INVENTION—FIELD OF INVENTION

This device is used to electronically collect depth information from a well—for example, hydrocarbon and water interface depths in contaminated groundwater areas.

### BACKGROUND OF INVENTION

In many industrial and commercial settings, groundwater must be monitored. Wells are built on such properties to enable this monitoring. Information is collected from these monitoring wells such as groundwater depth and floating contaminates depths; for instance, hydrocarbons (including oil).

These depths are commonly measured by lowering liquid sensing probes into the well. Examples of such probes include U.S. Pat. Nos. 2,789,435 and 3,148,314 which use capacitance as their sensing mechanism. There are other commercially available sensing mechanisms as well. These probes are attached to an indexed tape which encloses sensing wires. The probe is lowered into the well until it detects its calibrated liquid. At this time it sends a signal though the tape's sensing wires and notifies the operator via a light and or tone. The operator then visually reads the measurement from the indexed tape. FIG. 3 displays an example of this readily available device.

There are many disadvantages to such a process. First the well heads are often in tough-to-see locations, such as low to the ground or hidden by overgrown weeds and or other obstructions. A precise measurement is sometimes distorted by the angle the operator must read the index or the position the operator must obtain to see it.

The operator must then manually write down the depth measured to a sheet of paper. Errors are very frequent when this transcribing is accomplished. Many times, field conditions, including weather and industrial surroundings (noise, odors, hazardous chemicals, etc.) exacerbate this chance of error.

Data is usually collected at multiple wells over a period of time. The operator(s) often do their measurements at over a thousand wells over a period of one or two months.

After data is collected in the field, a data entry person enters it into a computer database. The information is eventually used in government agency reports and shared with the public for safety and other purposes. It also is used in modeling to determine trends and analyze prevention options; again, public safety being an end result. Accuracy is of extreme importance. Errors can cause dangerous conditions in the public's drinking water and liabilities for companies such as oil refineries and power plants.

It is well known in the industry that the current manual method of transferring the collected field data to the computer's database creates many of these undesirable errors.

Many times the recorded medium (paper) is difficult to read after arriving from the many wells in the field. Markings can be smeared from oil or water that are common in that environment. Some operators have poor penmanship. Additionally, errors can occur from the tedious job of manually entering the magnitude of data. All of these problems can result in critical data errors and misleading modeling.

Often, when engineers and scientists are utilizing the stored database, they see irregularities that they question—for example, a larger than expected change in depth from past measurements. These irregularities may be errors, and they require validation (re-measuring). This validation expends time and human labor. It would be preferred that the operator be alerted of the irregularity at the initial measurement for immediate validation.

### BACKGROUND OF INVENTION—OBJECTS AND ADVANTAGES

Accordingly, several objects and advantages of this invention are:
a) Less time to collect data because parts of the process are automated. This makes the process more efficient and expedites the time it takes to get data to the users and decision makers.
b) One technician can collect the data using this invention—in the previous methods, two technicians are commonly used to increase the accuracy and validity of the data.
c) Less human interaction/judgment from recording visual measurements for the data, resulting in fewer errors and more accurate and valid data.
d) Direct entry into the computer database, resulting in fewer errors and more accurate and valid data.
e) Additional trips are eliminated to validate or re-measure data. This makes the process more efficient and expedites the time it takes to get data to the users and decision makers.
f) Fewer errors—more reliable data.

Overall, the new well measuring device takes less human labor, deceases the data collection time, and increases the accuracy and validity of the data. Further objects and advantages of this invention will become apparent from a consideration of the drawings and ensuing description.

### SUMMARY

A well measuring device that collects depth data so operators do not have to manually record the data in the field and then again into a computer. The well measuring device is attached to the well head. A rotary encoder rotates as a probe/sensor is lowered into the well via a longitudinal strip of tape. The rotary encoder sends pulses to electrical circuitry and a handheld computer that stores longitudinal information. The information stored can be easily transferred to other computers and databases.

### DRAWINGS—FIGURES

FIG. 1 is a perspective view of the preferred embodiment of the well measuring device.

FIG. 2 is an exploded view of the preferred embodiment of the well measuring device.

FIG. 3 shows a typical well probe being lowered into a well.

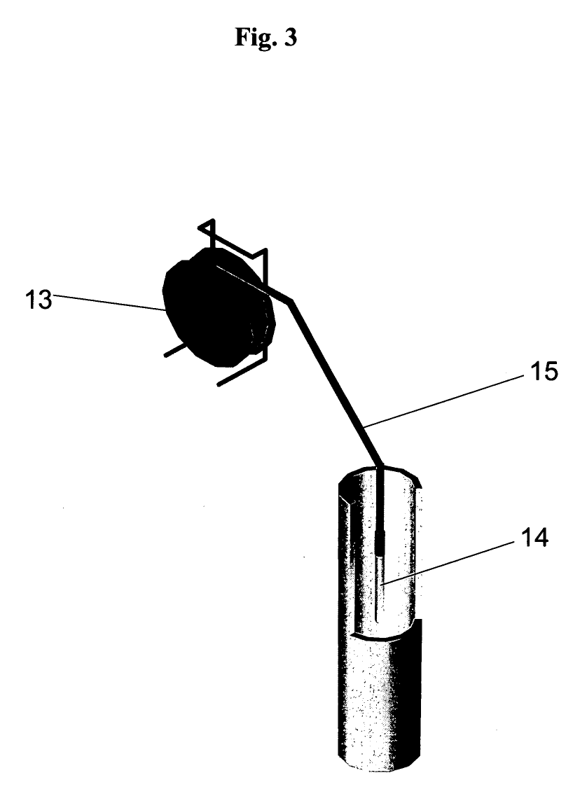

FIG. 4 shows how the well probe can fit through the well measuring device as it is being lowered into a well.

FIG. 5 shows an electrical block diagram of the electrical components used to count and convert the encoder's pulses to an ASCII hexadecimal number that the handheld computer can sense through a serial connection.

FIG. 6 shows the software flowchart for the logic programmed into the micro controller that is part of the electrical components used to count and convert the encoder's pulses to an ASCII hexadecimal number that the handheld computer can sense through a serial RS-232 connection.

FIG. 7 shows the software flowchart for the logic programmed into the handheld computer that is used to store the well data and as a user interface.

FIG. 8 shows the layout of a typical groundwater monitoring well.

### DRAWINGS—REFERENCE NUMERALS

13 Sensor Indicator
14 Sensor Probe
15 Sensor Measuring Tape
16 Plate
18 Plate
20 Roller
22 Roller
23 Roller
24 Spacer
25 Pin
26 Pin
28 Swing Arm
30 Swing Arm
32 Spacer
34 Spacer
36 Spacer
38 Pin
40 Pin
42 Pin
44 Pin
46 Pin
48 Coupling
50 Mounting Piece
52 Plate
54 Encoder
56 Electrical Circuitry Enclosure
58 Electrical Cable
60 Electrical Cable
62 Handheld Computer
63 GPS Receiver
64 Spacer
65 Spacer
66 Spacer
67 Spacer
68 Spacer
80 Power Source
82 Interpretation Logic Chips
84 Up/Down Counter Chips
86 Buffer Chips
88 Micro Controller

### DESCRIPTION OF THE PREFERED EMBODIMENT

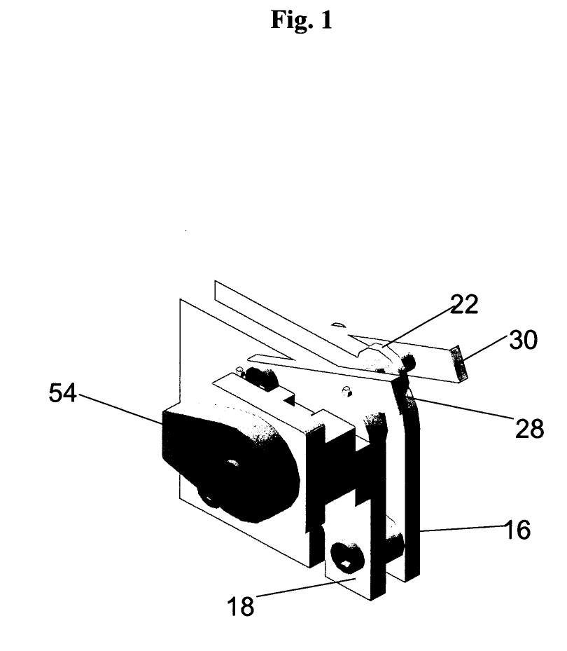

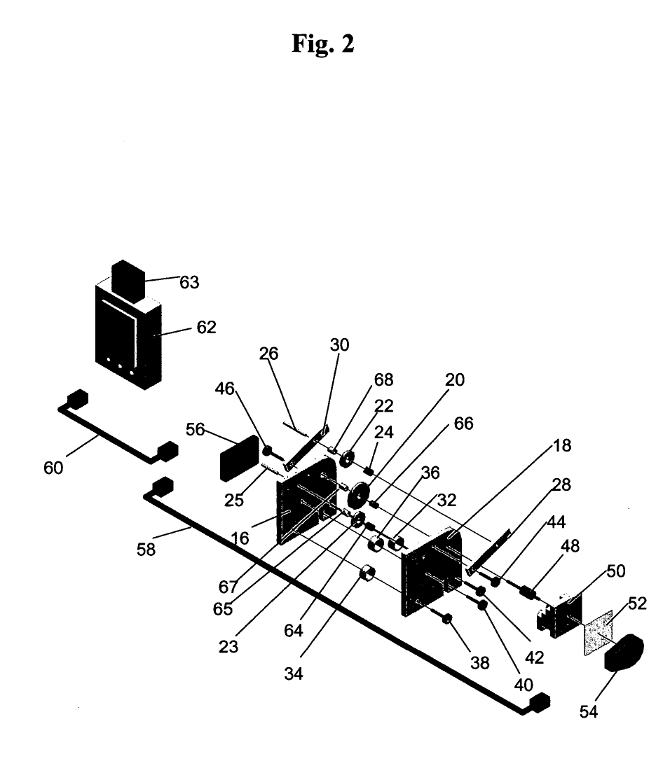

A preferred embodiment of the well measuring device is illustrated in FIGS. 1 and 2. FIG. 2 displays the parts in an exploded view.

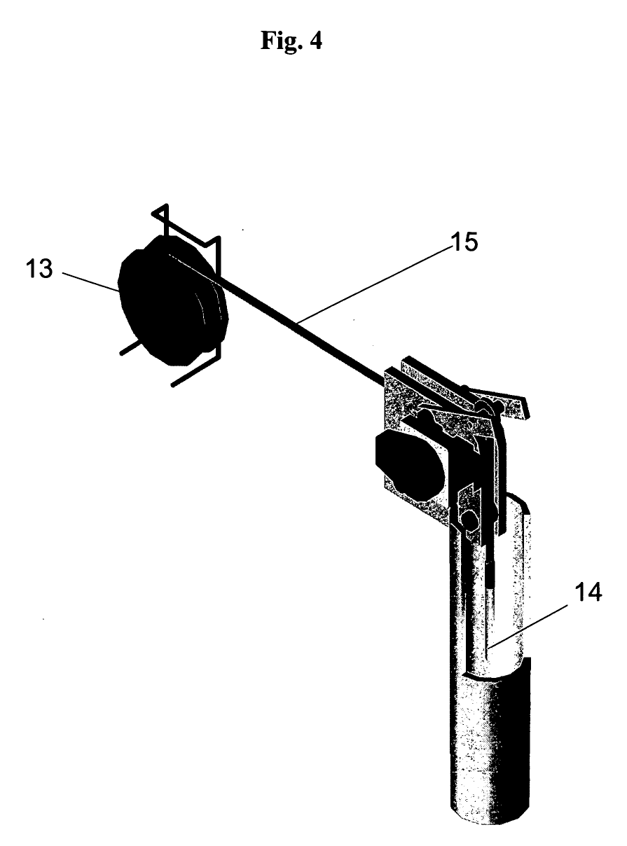

The well measuring device has two plates 16 and 18 that are attached by pin 38, 40 and 42. The plates 16 and 18 are separated by spacers 32, 34, and 36. The width of separation of the plates 16 and 18 is 0.5 inches, which is wide enough to fit a sensor measuring tape 15 between them as shown in FIG. 4.

Swing arms 28 and 30 are hinged to the plates 16 and 18 by pins 44 and 46. The swing arms 28 and 30 are attached at their upper ends by a pin 26. The swing arms 28 and 30 are separated by a spacer 24 a spacer 68, and a roller 22 all of which are hollow, and slip over the pin 26. The roller 22 fits centered between the spacer 24 and the spacer 68 between the swing arms 28 and 30.

Gravity causes the rest position of the swing arms to be at their lower point. In this position, roller 22 sits with its weight on top of a roller 20. Between the rollers 20 and 22 is where the sensor measuring tape 15 would be located during operations (see FIG. 4). Both rollers 20 and 22 have a knurled outer surface to create friction with the sensor measuring tape 15. The roller 20 is attached to a coupling 48. When the roller 20 rotates, the coupling 48 also rotates. The opposite end of the coupling 48 is attached to an encoder 54. The shaft of the encoder 54 rotates with the coupling 48. The roller 20 is centered between the plates 16 and 18 by a Spacer 66 and Spacer 67. The Spacers 66 and 67 are hollow and fit over the coupling 48.

A roller 23 is centered between the plates by a spacer 64 and a spacer 65. The roller 23, spacer 64 and spacer 65 are all hollow and fit over a pin 25. The ends of pin 25 are attached to the plates 16 and 18. The sensor measuring tape 15 (FIG. 4) sits on top of the roller 23.

The encoder 54 is attached to the plate 18 by a plate 52 and a mounting piece 50. The mounting piece 50 is shaped such that it fits around the swing arm 28 and the pin 44.

The encoder 54 is connected to an electrical cable 58. The other end of the electrical cable 58 connects to an electrical circuitry enclosure 56. The electrical circuitry enclosure 56 is attached with adhesive to the side of the plate 16.

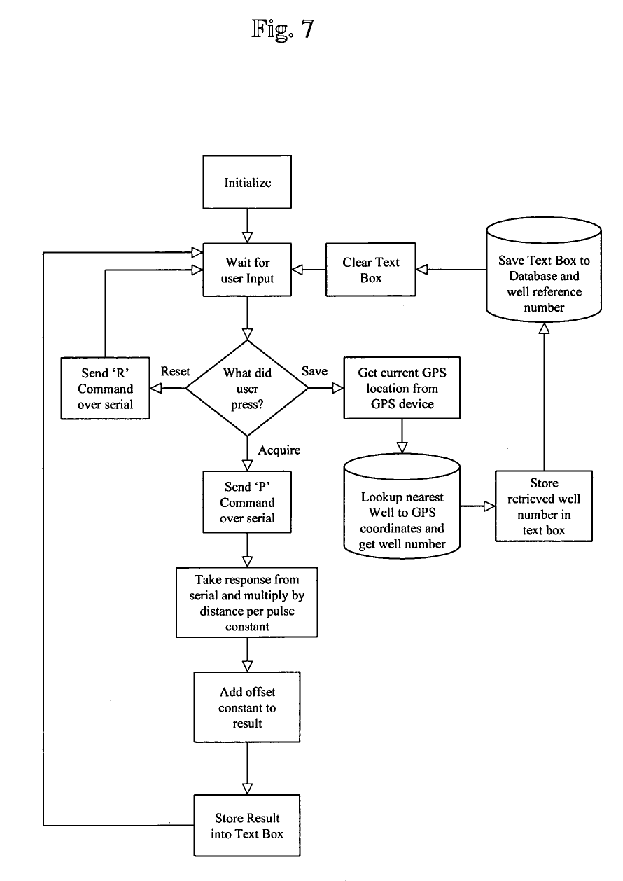

The electrical circuitry enclosure 56 is connected to an electrical cable 60. The other end of the electrical cable 60 connects to a handheld computer 62. The handheld computer has programmed logic which is shown in FIG. 7. In this preferred embodiment, the handheld computer 62 is equipped with a GPS (Globally Positioning System) receiver 63.

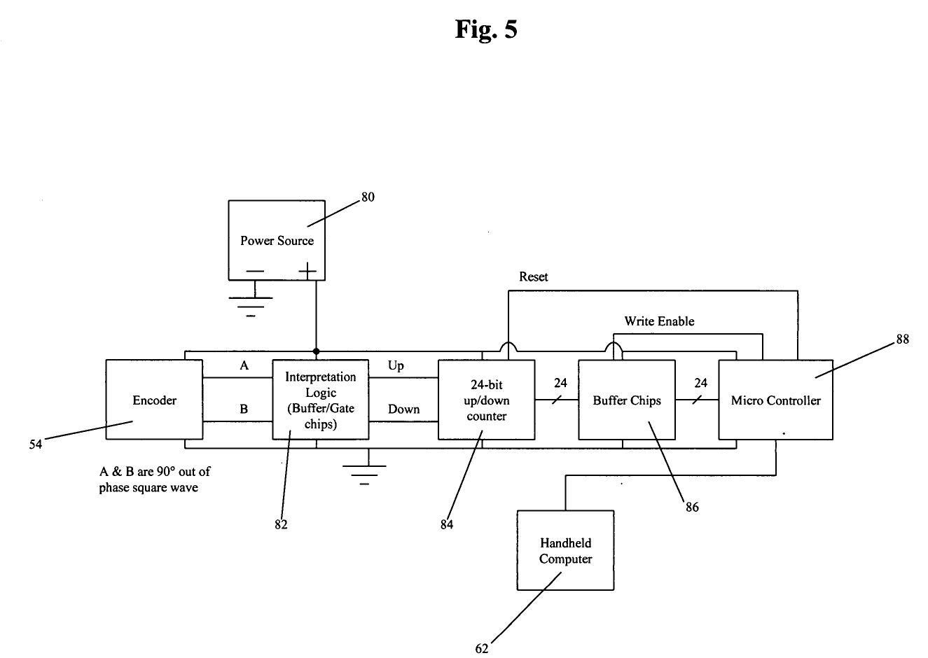

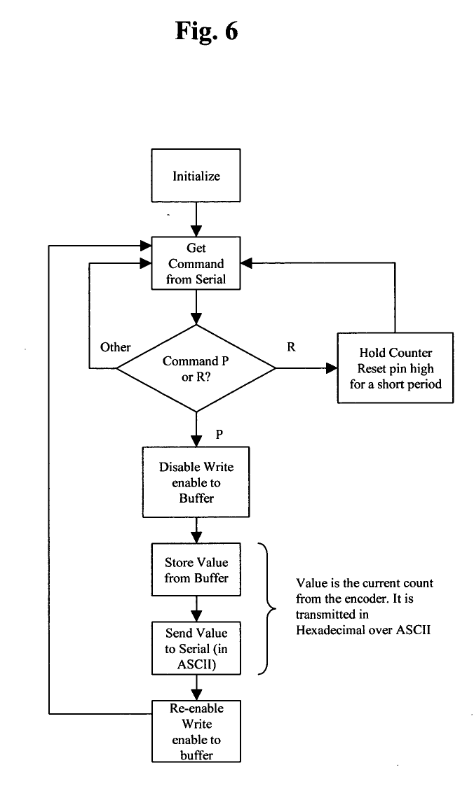

The electrical circuitry inside the enclosure 56 consists of many CMOS logic chips which are functionally grouped in FIG. 5. They are interconnected as shown in FIG. 5 and include a power source 80, a set of interpretation logic chips 82, a set of up/down counter chips 84, a set of buffer chips 86, a micro controller 88. The logic for the micro controller 88 is shown in FIG. 6.

The sensor measuring tape 15 connects to a sensor probe 14 both physically and electrically (there are wires inside the sensor measuring tape 15). The opposite end of the sensor measuring tape 15 electrically connects to a sensor indicator 13.

### OPERATION

The well measuring device is designed to be portably mounted on monitoring wells. The preferred embodiment has slots on the plates 16 and 18, which slips on the lip of a monitoring well as shown in FIG. 4. The operator would then lift the swing arms 28 and 30 and place the sensor probe 14 and the sensor measuring tape 15 through the opening it creates (below roller 22 and on top of roller 20). The operator lowers the swing arms 28 and 30 so the sensor measuring tape 15 is pressed (from gravity) between rollers 20 and 22. When the sensor measuring tape 15 moves, the rollers 20 and 22 also move via rotation. Because roller 20 is attached to the encoder 54 by way of the coupling 48, when roller 20 rotates, so does the encoder 54. Encoder 54 is a rotary style encoder which develops a pair of electrical pulses as it rotates. The pair of pulses have a phase difference such that someone who is skilled in this art can determine which direction the encoder 54 is rotating.

These pulses are connected to the interpretation logic chips 82 and then the up/down counter chips 84. The number of pulses is counted up when the sensor measuring tape is moving in a direction into the monitoring well and counts down when the sensor measuring tape is moving in a direction out of the well. This count value is passed to and stored in buffer chips 86. The micro controller 88 will grab this count value when its logic asks for it. FIG. 6 shows the logic flow diagram of how the micro controller 88 is programmed. When requested from the handheld computer 62, the micro controller 88 sends the count value in a serial ASCII format to the handheld computer 62.

The distance the sensor measuring tape has moved in a longitudinal direction down the monitoring well can be calculated by knowing the radius of the roller 20, the resolution (pulses per revolution) of the encoder 54, and the number of pulses the encoder 54 produces (count value to the handheld computer 62). The equation is:
Longitudinal Distance=2×pi×(Roller Radius)×(Number of Pulses)/(Encoder Resolution)

This longitudinal distance value is calculated and stored in a database inside the handheld computer 62 for that particular well. The particular well for the preferred embodiment is known because of previously defining its location with the GPS receiver 63. FIG. 7 shows the logic flow diagram of how the handheld computer 62 is programmed.

After feeding the sensor probe 14 and sensor measuring tape 15 through rollers 20 and 22, the operator lowers the sensor probe to a know offset point, which for the preferred embodiment, is the top of the sensor probe 14. This would locate the sensor probe 14 bottom tip a know distance into the monitoring well. The operator presses a “Reset” command on the handheld computer 62. The handheld computer 62 knows the sensor probe 14 is at the known offset point and can calculate its depth by knowing the number of pulse counts the encoder generates.

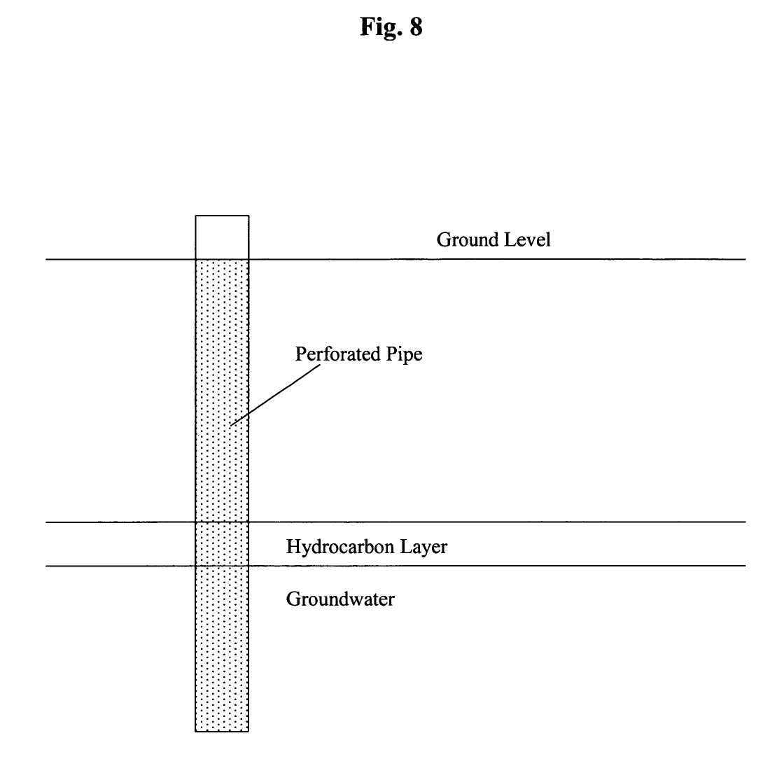

A typical application would be with a monitoring well which is used to monitor the depth of floating hydrocarbons (such as oil) on top of groundwater. Two measurements would be taken (see FIG. 8):
1. The distance from the top of the well to the top of the hydrocarbon.
2. The distance from the top of the well to the top of the groundwater.

The sensor probe 14 is electrically connected through the sensor measuring tape 15 to the sensor indicator 13. The sensor indicator 13 sounds an audible tone when the sensor probe 14 touches the hydrocarbon layer. The sensor indicator 13 sounds an alternate audible solid tone when the sensor probe 14 touches the groundwater layer. The sensor indicator 13 is silent in air.

After resetting the offset into the handheld computer 62, the operator lowers the sensor probe 14 until a hydrocarbon indicating tone is heard from the sensor indicator 13. The operator then slowly raises and lowers the sensor probe 14 to fine tune where the tone begins. The operator then presses an Acquire button on the handheld computer 62 to store the top of the hydrocarbon level into the monitoring well's database. When the Acquire button is pressed on the handheld computer 62, the count value from the micro controller is sent to the handheld computer 62, converted to distance, and stored in the data base. Now the operator continues to lower the sensor probe 14 into the well until the sensor indicator 13 produces a water indicating tone. The operator then slowly raises and lowers the sensor probe 14 to fine tune where the hydrocarbon indicating tone ends and the water indicating tone begins. The operator then presses the Acquire button on the handheld computer to store the top of the groundwater level into the monitoring wells database. When the Acquire button is pressed on the handheld computer 62, the count value from the micro controller is sent to the handheld computer 62 and converted to distance and stored in the data base.

The handheld computer 62 provides the operator with the past data for that monitoring well. After measuring, the operator compares the past data to this recent data. If there is a large discrepancy from past readings, the operator can recollect the data levels.

### CONCLUSION, RAMIFICATIONS, AND SCOPE

Thus, the reader will see, that the well measuring device of this invention, can be used in recording monitoring well depth data efficiently and accurately. The data is recorded automatically when the operator presses a button. No visual tape reading judgments are required. The data is stored directly into the database with no manual writing. Because the past measurement database is with the operator, past data is available to compare with the new data immediately in the field eliminating future trips and validation.

The well measuring device takes less time and less human labor to get data to the users. It takes less human judgment resulting in fewer errors. It uses direct entry so there are fewer errors. This efficiency and increased accuracy assist decision makers to make timely and more correct assessments and choices.

Although the description above contains many specificities, these should not be construed as limiting the scope of the invention, but as merely providing illustration of the presently preferred embodiment of this invention. For example, the mounting method to the monitoring well could have variations. Because of the design of some wells, intermediate interfaces may be included to allow the well measuring device to attach to the well. The types of sensor probes used with well measuring device can vary. For example, a probe which only measures water could be used for wells with no hydrocarbons present. Also, a GPS was used here to identify which well was being measured. There are other methods to determine the well to include barcode and Radio Frequency Identification (RFID) scanners and even manual entry. Although not discussed in the operation of the preferred embodiment, it very simple to transfer the data collected from the handheld computer to a desktop computer. Also not discussed in the preferred embodiment, Geographic Information Systems (GIS) can be used in the handheld computer to graphically abridge finding and identifying the wells to be measured.

1. A measuring device that collects depth information from wells.

2. The measuring device of claim 1 that has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly.

3. The measuring device of claim 1 that has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly. Said electrical components connect to a global positioning System (GPS) receiver to obtain positioning information for the wells.

4. The measuring device of claim 1 that has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly. Said electrical components connect to a bar code reading device that obtains identification information from the wells.

5. The measuring device of claim 1 that has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly. Said electrical components connect to a Radio Frequency Identification (RFID) reading device that obtains identification information from the wells.

6. The measuring device of claim 1 that has a housing that can attach to wells. Said housing has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly.

7. The measuring device of claim 1 that has a housing that can attach to wells. Said housing has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly. Said electrical components connect to a Global Positioning System (GPS) Receiver to obtain positioning information for the wells.

8. The measuring device of claim 1 that has a housing that can attach to wells. Said housing has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly. Said electrical components connect to a bar code reading device that obtains identification information from the wells.

9. The measuring device of claim 1 that has a housing that can attach to wells. Said housing has a rolling mechanism that rotates as a sensor tape assembly is lowered and raised in a well. Said rolling mechanism connects to a rotary encoder. Said rotary encoder is connected to electrical components that track and stores the displacement movement distance of the sensor tape assembly. Said electrical components connect to a Radio Frequency Identification (RFID) reading device that obtains identification information from the wells.
